(19) United States
(12) Patent Application Publication
(10) Pub. No.: US 2025/0056078 A1
(43) Pub. Date: Feb. 13, 2025

(54) SERVER, METHOD AND COMPUTER PROGRAM

(71) Applicant: 17LIVE Japan INC., Tokyo (JP)

(72) Inventors: Yung-Chi HSU, Taipei City (TW); Chun-Sheng HSU, Taipei City (TW); Tsung-Tai SHIH, Taipei City (TW); Chin-Wei LIU, Taipei City (TW); Che-Wei HU, Taipei City (TW)

(21) Appl. No.: 18/678,076

(22) Filed: May 30, 2024

(30) Foreign Application Priority Data
Aug. 10, 2023 (JP) 2023-131438

(51) Int. Cl. H04N 21/266; G06F 40/35; G06T 13/00; H04N 21/2187; H04N 21/25; H04N 21/81

(52) U.S. Cl. CPC H04N 21/266; G06F 40/35; G06T 13/00; H04N 21/2187; H04N 21/251; H04N 21/8146

(57) ABSTRACT

A server for handling interaction in a live streaming platform, comprising one or a plurality of processors, wherein the one or plurality of processors execute a machine-readable instruction to perform: receiving a character data corresponding to a character; feeding the character data into a machine learning model to generate a virtual chatbot in a live streaming room; setting the virtual chatbot in the live streaming room; wherein the virtual chatbot is configured to provide assistance to a livestreamer or viewers in the live streaming room. According to the present disclosure, the AI chatbot with a character may increase the interaction and fun in the live streaming room. Moreover, the monitoring and handling of the atmosphere in the live streaming may also be partially or entirely entrusted to the AI chatbot. Therefore, the user experience may be improved.

### CROSS-REFERENCE TO RELATED APPLICATIONS

This application is based on and claims the benefit of priority from Japanese Patent Application Serial No. 2023-131438 (filed on Aug. 10, 2023), the contents of which are hereby incorporated by reference in their entirety.

### BACKGROUND OF THE DISCLOSURE

### Technical Field

This disclosure relates to information and communication technology, and in particular, to a server, method and computer program in a live streaming.

### Description of Related Art

Some APPs or platforms provide live streaming service for livestreamers and viewers to interact with each other. The livestreamers may have a performance to cheer up the viewer and the viewer may send gifts to support the livestreamers.

Sometimes if the viewers do not cheer up the livestreamer, the livestreamer may feel depressed and the interaction between viewers and livestreamer may get worse and worse. Patent Document 1 disclosed a method to solve the problem of insufficient activity of the live broadcast room by generating a virtual intelligent robot.

However, the livestreamers may have more and more interaction with the viewer and the current chatbot may not satisfy the need from the livestreamer. Moreover, the function of chatbot is always fixed and limited, and this may lead to poor user experience. Therefore, how to improve the user experience is very important.
[Patent Document 1]: CN110730390A

### SUMMARY OF THE DISCLOSURE

An embodiment of subject application relates to a server for handling interaction in a live streaming platform, comprising one or a plurality of processors, wherein the one or plurality of processors execute a machine-readable instruction to perform: receiving a character data corresponding to a character; feeding the character data into a machine learning model to generate a virtual chatbot in a live streaming room; setting the virtual chatbot in the live streaming room; wherein the virtual chatbot is configured to provide assistance to a livestreamer or viewers in the live streaming room.

Another embodiment of subject application relates to a method for handling interaction in a live streaming platform, comprising: receiving a character data corresponding to a character; feeding the character data into a machine learning model to generate a virtual chatbot in a live streaming room; setting the virtual chatbot in the live streaming room; wherein the virtual chatbot is configured to provide assistance to a livestreamer or viewers in the live streaming room.

Another embodiment of subject application relates to a computer program for causing a server to realize the functions of: receiving a character data corresponding to a character; feeding the character data into a machine learning model to generate a virtual chatbot in a live streaming room; setting the virtual chatbot in the live streaming room; wherein the virtual chatbot is configured to provide assistance to a livestreamer or viewers in the live streaming room.

According to the present disclosure, the AI chatbot with a character may increase the interaction and fun in the live streaming room. Moreover, the monitoring and handling of the atmosphere in the live streaming may also be partially or entirely entrusted to the AI chatbot.

Therefore, the user experience may be improved.

### BRIEF DESCRIPTION OF THE DRAWINGS

FIG. 1 is a schematic configuration of a live streaming system 1 according to some embodiments of subject application;

FIG. 2 is a schematic block diagram of the user terminal 20 according to some embodiments of subject application;

FIG. 3 is a schematic block diagram of the server 10 according to some embodiments of subject application;

FIG. 4 shows an exemplary data structure of the stream DB 320 of FIG. 3;

FIG. 5 shows an exemplary data structure of the user DB 322 of FIG. 3;

FIG. 6 shows an exemplary data structure of the AI chatbot DB 324 of FIG. 3;

FIG. 7 shows an exemplary data structure of the training data DB 326 of FIG. 3;

FIG. 8 shows an exemplary data structure of the personality DB 328 of FIG. 3;

FIG. 9 is exemplary functional configuration of the live streaming system 1 according to some embodiments of subject application;

FIG. 10-FIG. 15 are exemplary screen images of a live-streaming room screen 600 shown on the display of the livestreamer user terminal 20 or the viewer user terminal 30;

FIG. 16 is a flowchart showing steps of an application activation process on the user terminals 20 and 30;

FIG. 17 is exemplary functional configuration of the live streaming system 1 according to some embodiments of subject application;

FIG. 18 is an exemplary hardware configuration of the information processing device according to some embodiments of subject application.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

The live streaming system 1 according to some embodiments of subject application provides enhancement among the users to communicate and interact smoothly. More specifically, it entertains the viewers and livestreamers in a technical way.

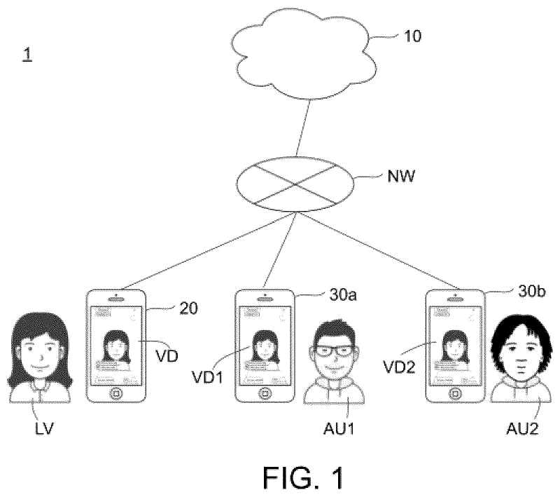

FIG. 1 shows a schematic configuration of a live streaming system 1 according to some embodiments of subject application. The live streaming system 1 provides a live streaming service for the streaming livestreamer (may also be referred as liver, streamer or distributor) LV and viewer (may also be referred as audience) AU (AU1, AU2 . . . ) to interact mutually in real time. As shown in FIG. 1, the live streaming system 1 may include a server 10, a user terminal 20 and a user terminal 30 (30a, 30b . . . ). The user terminal 20 may be a livestreamer and the user terminal 30 may be a viewer. In some embodiments, the livestreamers and viewers may be referred to as the user. The server 10 may include one or a plurality of information processing devices connected via network NW. The user terminal 20 and 30 may be, for example, a portable terminal such as the smartphone, tablet, laptop PC, recorder, mobile game console, wearable device or the like, or the stationary computer such as desktop PC. The server 10, user terminal 20 and user terminal 30 may be communicably connected by any type of wire or wireless network NW.

The live streaming system 1 is involved in the livestreamer LV, the viewer AU, and APP provider (not shown), who provides the server 10. The livestreamer LV may record his/her own contents such as songs, talks, performance, game streaming or the like by his/her own user terminal 20 and upload to the server 10 and be the one who distributes contents in real time. In some embodiments, the livestreamer LV may interact with the viewer AU via the live streaming.

The APP provider may provide a platform for the contents to go on live streaming in the server 10. In some embodiments, the APP provider may be the media or manager to manage the real time communication between the livestreamer LV and viewer AU. The viewer AU may access the platform by the user terminal 30 to select and watch the contents he/she would like to watch. The viewer AU may perform operations to interact with the livestreamer, such as commenting or cheering the livestreamer, by the user terminal 30. The livestreamer, who provides the contents, may respond to the comment or cheer. The response of the livestreamer may be transmitted to the viewer AU by video and/or audio or the like. Therefore, a mutual communication among the livestreamer and viewer may be accomplished.

The “live streaming” in this specification may be referred to as the data transmission which enables the contents the livestreamer LV recorded by the user terminal 20 to be substantially reproduced and watched by the viewer AU via the user terminal 30, In some embodiments, the “live streaming” may also refer to the streaming which is accomplished by the above data transmission. The live streaming may be accomplished by the well-known live streaming technology such as HTTP Live Streaming, Common Media Application Format, Web Real-Time Communications, Real-Time Messaging Protocol, MPEG DASH or the like. The live streaming may further include the embodiment that the viewer AU may reproduce or watch the contents with specific delay while the livestreamer is recording the contents. Regarding the magnitude of the delay, it should be at least small enough to enable the livestreamer LV and the viewer AU to communicate. However, live streaming is different from so-called on-demand streaming. More specifically, the on-demand streaming may be referred to as storing all data, which records the contents, in the server and then providing the data from the server to the user at random timing according to the user's request.

The “streaming data” in this specification may be referred to as the data includes image data or voice data. More specifically, the image data (may be referred to as video data) may be generated by the image pickup feature of the user terminal 20 and 30. The voice data (may be referred to as audio data) may be generated by the audio input feature of the user terminal 20 and 30. The streaming data may be reproduced by the user terminal 20 30, so that the contents relating to users may be available for watching. In some embodiments, during the period from the streaming data being generated by the user terminal of the livestreamer to being reproduced by the user terminal of the viewer, the processing of changing format, size or specification of the data, such as compression, extension, encoding, decoding, transcoding or the like, is predictable. Before and after this kind of processing, the contents (such as video and audio) are substantially unchanged, so it is described in the current embodiments of the present disclosure that the streaming data before being processed is the same as that after being processed. In other words, if the streaming data is generated by the user terminal of the livestreamer and reproduced by the user terminal of the viewer via the server 10, the streaming data generated by the user terminal of the livestreamer, the streaming data passed through the server 10 and the streaming data received and reproduced by the by the user terminal of the viewer are all the same streaming data.

As shown in FIG. 1, the livestreamer LV is providing the live streaming. The user terminal 20 of the livestreamer generates the streaming data by recording his/her video and/or audio, and transmits to the server 10 via the network NW. At the same time, the user terminal 20 may display the video VD on the display of the user terminal 20 to check the streaming contents of the livestreamer LV.

The viewer AU1, AU2 of the user terminal 30a, 30b, who request the platform to provide the live streaming of the livestreamer, may receive streaming data corresponding to the live streaming via the network NW and reproduce the received streaming data to display the video VD1, VD2 on the display and output the audio from a speaker or the like. The video VD1, VD2 displayed on the user terminal 30a, 30b respectively may be substantially the same as the video VD recorded by the user terminal of the livestreamer LV, and the audio outputted from the terminal 30a, 30b may also be substantially the same as the audio recorded by the user terminal of the livestreamer LV.

The recording at the user terminal 20 of the livestreamer may be simultaneous with the reproducing of the streaming data at the user terminal 30a, 30b of the viewer AU1, AU2. If a viewer AU1 inputs a comment on the contents of the livestreamer LV into the user terminal 30a, the server 10 will display the comment on the user terminal 20 of the livestreamer in real time, and also display on the user terminal 30a, 30b of the viewer AU1, AU2 respectively. If the livestreamer LV responds to the comment, the response may be outputted as the text, image, video or audio from the terminal 30a, 30b of the viewer AU1, AU2, so that the communication of the livestreamer LV and viewer LV may be realized. Therefore, the live streaming system may realize the live streaming of two-way communication.

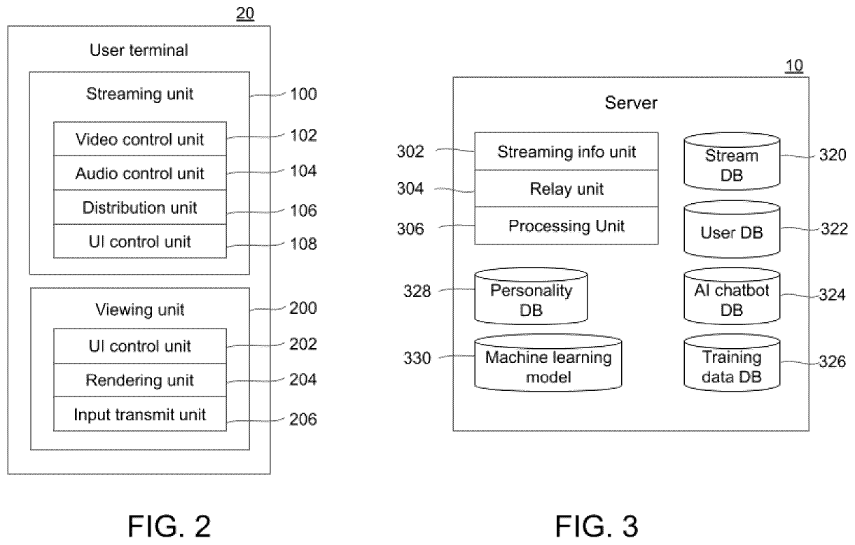

FIG. 2 is a block diagram showing a function and configuration of the user terminal 20 in FIG. 1 according to the embodiment of the present disclosure. The user terminal 30 has the similar function and configuration of the user terminal 20. The blocks depicted in the block diagram of this specification are implemented in hardware such as devices like a CPU of a computer or mechanical components, and in software such as a computer program depicts functional blocks implemented by the cooperation of these elements. Therefore, it will be understood by those skilled in the art that the functional blocks may be implemented in a variety of manners by a combination of hardware and software.

The livestreamer LV and viewer AU may download and install the live streaming application (live streaming APP) of the present disclosure to the user terminal 20 and 30 from the download site via network NW. Or the live streaming APP may be pre-installed in the user terminal 20 and 30. By the execution of the live streaming by the user terminal 20 and 30, the user terminals 20 and 30 may communicate with the server 10 via the network NW to realize a plurality of functions. The functions realized by the execution of the live streaming APP by the user terminal 20 and 30 (More specifically, the processor such as CPU) is described below as the functions of the user terminal 20 and 30. These functions are basically the functions that the live streaming APP makes the user terminals 20 and 30 realize. In some embodiments, these functions may also be realized by transmitting from the server 10 to the web browser of the user terminal 20 and 30 via network NW and be executed by the computer program of the web browser. The computer program may be written in the programming language such as HTML (Hyper Text Markup Language) or the like.

The user terminal 20 includes streaming unit 100 and viewing unit 200. In some embodiments, the streaming unit 100 is configured to record the audio and/or video data of the user and generate streaming data to transmit to the server 10. The viewing unit 200 is configured to receive and reproduce streaming data from server 10. In some embodiments, a user may activate the streaming unit 100 when broadcasting or activate the viewing unit 200 when watching streaming respectively. In some embodiments, the user terminal who is activating the streaming unit 100 may be referred to as a live streamer or be referred to as the user terminal which generates the streaming data. The user terminal who is activating the viewing unit 200 may be referred to as a viewer or be referred to as the user terminal which reproduces the streaming data.

The streaming unit 100 may include video control unit 102, audio control unit 104, distribution unit 106 and UI control unit 108. The video control unit 102 may be connected to a camera (not shown) and the video is controlled by the camera. The video control unit 102 may obtain the video data from the camera. The audio control unit 104 may be connected to a microphone (not shown) and the audio is controlled by the microphone. The audio control unit 104 may obtain the audio data from the microphone.

The distribution unit 106 receives streaming data, which includes video data from the video control unit 102 and audio data from the audio control unit 104, and transmits to the server 10 via network NW. In some embodiments, the distribution unit 106 transmits the streaming data in real-time. In other words, the generation of the streaming data from the video control unit 102 and audio control unit 104, and the distribution of the distribution unit 106 is performed simultaneously.

UI control unit 108 controls the UI for the livestreamer. The UI control unit 108 is connected to a display (not shown) and is configured to generate the streaming data to whom the distribution unit 106 transmits, reproduces and displays the streaming data on the display. The UI control unit 108 shows the object for operating or the object for instruction-receiving on the display and is configured to receive the tap input from the livestreamer.

The viewing unit 200 may include UI control unit 202, rendering unit 204 and input transmit unit 206. The viewing unit 200 is configured to receive streaming data from server 10 via network NW. The UI control unit 202 controls the UI for the viewer. The UI control unit 202 is connected to a display (not shown) and/or speaker (not shown) and is configured to display the video on the display and output the audio from the speaker by reproducing the streaming data. In some embodiments, Outputting the video on the display and audio from the speaker may be referred to as “reproducing the streaming data”. The UI control unit 202 may be connected to an input unit such as touch panel, keyboard or display or the like to obtain input from the users.

The rendering unit 204 may be configured to render the streaming data from the server 10 and the frame image. The frame image may include user interface objects for receiving input from the user, the comments inputted by the viewers and the data received from the server 10. The input transmit unit 206 is configured to receive the user input from the UI control unit. 202 and transmit to the server 10 via the network NW.

In some embodiments, the user input may be clicking an object on the screen of the user terminal such as selecting a live stream, entering a comment, sending a gift, following or unfollowing a user, voting in an event, gaming or the like. For example, the input transmit unit 206 may generate gift information and transmit to server 10 via the internet NW if the user terminal of the viewer clicks a gift object on the screen in order to send a gift to the livestreamer.

FIG. 3 is a schematic block diagram of the server 10 according to some embodiments of the subject application. The server 10 may include streaming info unit 302, relay unit 304, processing unit 306, stream DB 320, user DB 322, AI chatbot DB 324, training data DB 326, personality DB 328 and machine learning model 330. In some embodiments, the machine learning model 330 may be a language model 330 or the like.

The streaming info unit 302 receives the request of live streaming from the user terminal 20 of the livestreamer via the network NW. Once receiving the request, the streaming info unit 302 registers the information of the live streaming on the stream DB 320. In some embodiments, the information of the live streaming may be the stream ID of the live streaming and/or the livestreamer ID of the livestreamer corresponding to the live streaming.

Once receiving the request of providing the information of the live streaming from the viewing unit 200 of the user terminal 30 from the viewer via the network NW, the streaming info unit 302 refers to the stream DB 320 and generates a list of the available live streaming.

The streaming info unit 302 then transmits the list to the user terminal 30 via the network NW. The UI control unit 202 of the user terminal 30 generates a live streaming selection screen according to the list and displays the list on the display of the user terminal 30.

Once the input transmit unit 206 of the user terminal 30 receives the selection of the live streaming from the viewer on the live streaming selection screen, it generates the streaming request including the stream ID of the selected live streaming and transmits to the server 10 via the network. The streaming info unit 302 may start to provide the live streaming, which is specified by the stream ID in the streaming request, to the user terminal 30. The streaming info unit 302 may update the stream DB 320 to add the viewer's viewer ID of the user terminal 30 to the livestreamer ID of the stream ID.

The relay unit 304 may relay the transmission of the live streaming from the user terminal 20 of the livestreamer to the user terminal 30 of the viewer in the live streaming started by the streaming info unit 302. The relay unit 304 may receive the signal, which indicates the user input from the viewer, from the input transmit unit 206 while the streaming data is reproducing. The signal indicating the user input may be the object-designated signal which indicates the designation of the object shown on the display of the user terminal 30.

The object-designated signal may include the viewer ID of the viewer, the livestreamer ID of the livestreamer, who delivers the live streaming the viewer is viewing, and object ID specified by the object. If the object is a gift or the like, the object ID may be the gift ID or the like. Similarly, the relay unit 304 may receive the signal indicating the user input of the livestreamer, for example the object-designated signal, from the streaming unit 100 of the user terminal 20 while the streaming data is reproducing.

The processing unit 306 is configured to process requests in response to operations from a user terminal of a user. For example, the user may click on a button to generate an AI chatbot in the live streaming room. The users may select their desired chatbot according to their preference. Once the relay unit 304 receives the request, the processing unit 306 may refer to a corresponding database such as the training data DB 326 according to their selections.

In some embodiments, server 10 may provide some default AI chatbot for the user. The training data corresponding to the default AI chatbot may be stored in the training data DB 326 in advance. In some embodiments, the processing unit 306 may also retrieve data internally or externally and store the related information as training data in the training data DB 326. For example, if the selected chatbot is a celebrity, the processing unit 306 may refer to his or her social media site, such as Facebook or Instagram, and retrieve the record as training data.

If the selected chatbot is a user in the live streaming platform, the processing unit 306 may refer to the user DB 322, the user's live streaming, archived streaming, the user's post or even the user's social media site, and further retrieve the record as training data. Moreover, If the selected chatbot is an animation character, the processing unit 306 may refer to the official website or the like. In some embodiments, the resource of the training data may be determined flexibly according to the practical need.

In some embodiments, the processing unit 306 may further feed the training data into a machine learning model for generating an AI chatbot or the like. In some embodiments, the machine learning model may be an internal-trained model or a model provided by a third-party service provider. In some embodiments, the machine learning model for generating an AI chatbot may be realized by a Language Model or the like. In some embodiments, the machine learning model may be an AI Chatbot such as ChatGPT or other LLM (large language model) or the like. In some embodiments, the machine learning technique may be realized by any possible model according to the practical need.

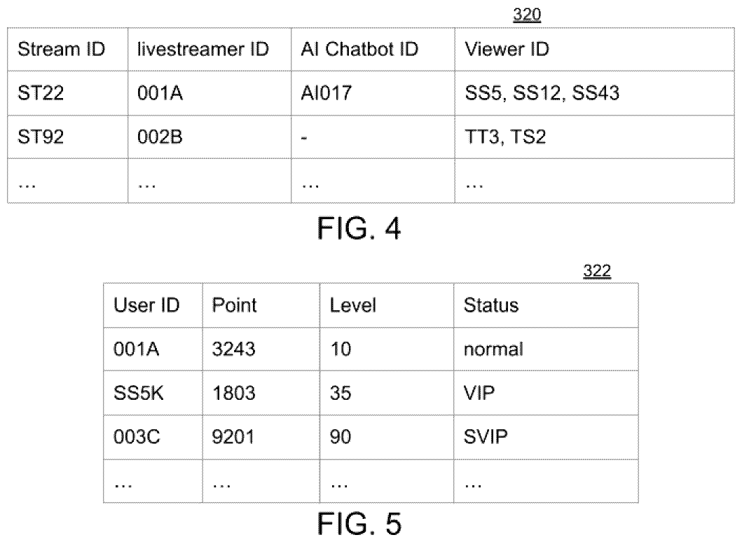

FIG. 4 shows an exemplary data structure of the stream DB 320 of FIG. 3. The stream DB 320 holds information regarding a live stream currently taking place. The stream DB 320 stores a stream ID for identifying a live-stream on a live distribution platform provided by the live-streaming system 1, a livestreamer ID for identifying the livestreamer who provides the live-stream, an AI chatbot ID for identifying an AI chatbot in the live streaming room, and a viewer ID for identifying a viewer of the live-stream, in association with each other. In some embodiments, an AI chatbot may be bound to a user as the creator. In some embodiments, the AI chatbot may be bound to a live-stream. In some embodiments, the AI chatbot may move across different live streaming rooms.

FIG. 5 shows an exemplary data structure of the user DB 322 of FIG. 3. The user DB 322 holds information regarding users. The user DB 322 stores a user ID for identifying a user, points for identifying the points the user accumulates, level for identifying the level of the user and status for identifying the status of the user in association with each other. The point is the electronic value circulated within the live-streaming platform. The level may be an indicator of the amount of user activity or engagement on the live streaming platform. The status may be an identity or membership status of the user on the live streaming platform.

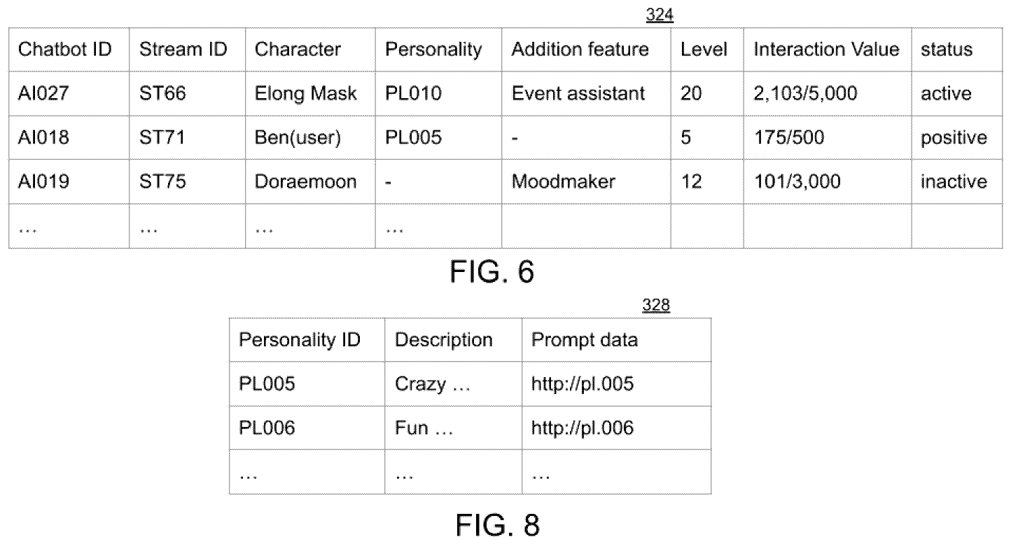

FIG. 6 shows an exemplary data structure of the AI chatbot DB 324 of FIG. 3. The AI chatbot DB 324 holds information regarding an AI chatbot on the live distribution platform. The AI chatbot DB 324 stores a chatbot ID for identifying an AI chatbot provided by the live-streaming system 1 or generated by the users, a stream ID for identifying a live-stream the chatbot is currently located at, a character for identifying the character of the chatbot, a personality for identifying the personality of the chatbot, an addition feature for identifying the addition feature of the chatbot, in association with each other.

In some embodiments, the app provider may provide some default chatbot in advance or the chatbot may be generated by users in real-time. The chatbot may be generated in a live streaming room and may move across different live streaming rooms. In some embodiments, one chatbot may also appear in different live streaming rooms. In some embodiments, the character may be a celebrity, a famous person, a user in the live streaming platform, an animation character, an occupation such as lawyer, or any possible characters.

The personality may be an individual characteristic of a human being. For example, the chatbot may have the personality of positive, negative, talkative, silent, impatient, patient, high-profile, low profile, gentle, violent, sympathetic, ruthless or the like. In some embodiments, one character may have a default personality. For example, the famous scientist Albert Einstein is considered a thoughtful and imaginative genius. In some embodiments, the character may have no personality. For example, the Chatbot may comment or respond just like a robot.

In some embodiments, the personality of the character may be set or changed. For example, the user may generate an Einstein with the personality of being impatient, talkative or the like. In some embodiments, the character may have an opposite personality which contrasts with its usual impression. For example, a user is considered to be a silent person, and an AI chatbot of the user with the personality of talkative may be generated. According to the embodiments, the sense of contrast between the AI chatbot and the user may bring fun to the live streaming room.

In some embodiments, the personality may be shown by the AI chatbot according to a term, vocabulary, and diction of the text message, a tone, pitch, timbre, tempo, speed, and diction of the audio message, or facial features, gesture, motion of a video message from the virtual chatbot. For example, the AI chatbot with personality of having sensor of humor may tell jokes sometimes, and the AI chatbot with personality of pessimistic may frown or say something negative or the like.

In some embodiments, the addition feature may be a function of the chatbot in the live streaming room. The additional feature may be set by the user according to the situation of the live streaming room. For example, the chatbot may be an event assistant. The event assistant may help the streamer with the event if the streamer is now involved in an event held by the live streaming platform. The AI chatbot may provide the livestreamer or viewers with a hint message to help the livestreamer meet the reward threshold in an event.

During the event, the processing unit 306 may keep monitoring the status of the live streaming room and provide hint messages according to the status. The status may be a specific time point such as the last five minutes before the end of the event. The status may also be a specific status such as the receiving point of the livestreamer is decreasing or the like. This kind of information may be considered as a trigger for the processing unit 306 to provide hint messages according to the machine learning model.

In some embodiments, the chatbot may also suggest the livestreamer on interacting with the viewer such as singing a song or playing a guitar to cheer up the audience. In some embodiments, the chatbot may also notify the viewer of the goal for the livestreamer to win or meet the reward threshold in an event. For example, a hint message of “the livestreamer needs 2,000 points to win. How about donating 4 small event gifts (500) or 1 big event gift (2,000).” may be displayed via the AI chatbot to guide the viewer for helping the livestreamer.

The chatbot may also be a moodmaker in the live streaming room. Once the atmosphere in the live streaming room is down, the chatbot may cue an audience or initiate a topic to increase the interaction between the livestreamer and viewer. In some embodiments, the atmosphere of the live streaming room may be determined, for example, by the number of viewers, number of comments, contents of comments, number of gifts, value of gifts or the like. In some embodiments, once the interaction is lower than a threshold, the chatbot may be activated and function as a moodmaker to increase the atmosphere in the live streaming room.

In some embodiments, The AI chatbot DB 324 may further store a level for identifying the level of the chatbot, an interaction value for identifying the degree of interaction with the users and status for identifying the current status of the chatbot, in association with each other. The status may indicate the current status of the chatbot such as “active”, “inactive”, “freezed”, “destroyed” or the like. The status of “active” and “inactive” may refer to that the chatbot is currently activated or inactivated. In some embodiments, the status of the chatbot may be designed and determined flexibly according to the practical need.

In some embodiments, the chatbot may have different levels and interaction value. The interaction value may be obtained by interaction with the users such as by tagging a user, commenting, responding to a user, providing hint messages or the like. The level may be upgraded by receiving enough interaction value. In some embodiments, the function of the chatbot may be unlocked according to the level or the like. In some embodiments, the interaction from the chatbot may be changed according to the level.

In some embodiments, different levels may correspond to different ages and the comment and topic may vary based on the level. For example, the AI chatbot with ages under twelve may behave like a child and with ages over forty may be much more mature or the like. In other words, the training data may be changed or added according to the level of the chatbot. In some embodiments, the processing unit 306 may further retrieve training data according to the level of the AI chatbot or the like.

In some embodiments, the status of the AI chatbot may change according to the interaction of the AI chatbot with the users in the live streaming room. In some embodiments, the status may further include emotional status such as “happy”, “annoyed”, “sad”, “depressed”, “lonely” or the like. For example, if the interaction between the AI chatbot and the users is positive or negative, the status of the AI chatbot may be positive or negative such as “happy” or “sad”. In some embodiments, the increase in the interaction value may vary according to the status. For example, the interaction value may increase faster while being in the positive status than in the negative status.

In some embodiments, the status of the AI chatbot may also be referred to as the health point (HP) of the AI chatbot. In some embodiments, the status of the AI chatbot may also change according to the interaction from the users. For example, the status may be “lonely”, “depressed”, “weak” or “at risk” if there is less or no interaction from the users. In some embodiments, if the status of the AI chatbot stays negative over a specific period of time, the AI chatbot may be unworkable for the time being or forever. For example, if no user interacts with the AI chatbot over one hour, the AI chatbot may be destroyed forever.

In some embodiments, the status of the AI chatbot may also change the interaction of the AI chatbot with the users. For example, if the AI chatbot is in a negative status, the message from the AI chatbot may become negative or the like. In some embodiments, the status of the AI chatbot may also be displayed in the profile page, display image or message of the AI chatbot. In some embodiments, the status of the AI chatbot may also be displayed on an icon in the live streaming such as the icon 618 in FIG. 12 or the like. According to the embodiments, the user may understand the status of the AI chatbot and interact with the AI chatbot when necessary.

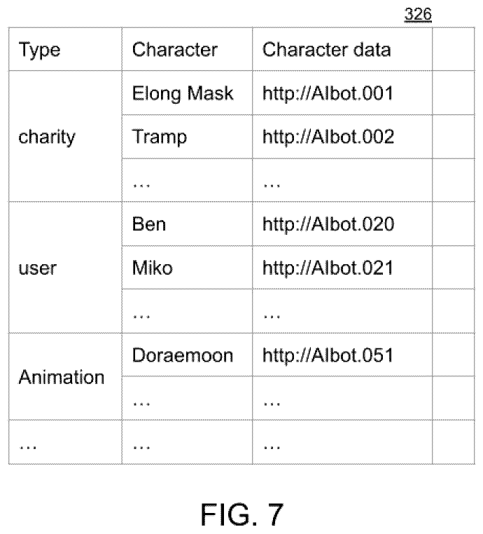

FIG. 7 shows an exemplary data structure of the training data DB 326 of FIG. 3. The training data DB 326 holds information regarding the training data of an AI chatbot. The training data DB 326 stores a character for identifying the character of the chatbot, a type for identifying the type of the character and a character data for identifying the training data of the character, in association with each other.

In some embodiments, the type of character may include “charity”, “user”, “animation” or the like. The type of “charity” may refer to a famous and well-known person. The person may be an actor, actress, scientist, politician or the like. The type of “user” may refer to a user in the live streaming platform. The user may be a famous user in the live streaming platform, or a follower, followee, friend of another user in the live streaming room. The type of “animation” may refer to a virtual character from animation such as Doraemon, super Mario, Pikachu or the like.

In some embodiments, the training data of the character may be retrieved according to the type of the character. For example, the training data of a charity may be retrieved from the public information of the social media sites such as Facebook, Instagram, twitter or the like. The training data of a user may be retrieved from the uploaded information of the user in the live streaming platform, and also from their social media sites or the like. According to the embodiments, it may motivate the user to post more information on the live streaming platform.

Moreover, the training data of the animation character may be retrieved from its official website, animation, online search results or the like. In some embodiments, the training data may be retrieved flexibly according to the practical need. In some embodiments, the data may be downloaded in advance or retrieved from the internet in real-time. The data may be stored in the training data DB 326 for training. In some embodiments, the training data may be classified according to, for example, the level of the AI chatbot or the like. In some embodiments, the training data may be added, deleted, adjusted or the like flexibly.

FIG. 8 shows an exemplary data structure of the personality DB 328 of FIG. 3. The personality DB 328 holds information regarding the personality data of an AI chatbot. The personality DB 328 stores a personality ID for identifying the personality of the chatbot, a description for identifying the description of personality and a prompt data for identifying the prompt data of the personality, in association with each other.

In some embodiments, the personality may be a prompt data for the language model. The prompt may refer to the input text or instructions provided to the language model to generate responses or perform specific tasks. In some embodiments, the prompt data may be a sentence or paragraph to indicate a specific personality of a chatbot. For example, the prompt data may be “you are a well-educated, polite and patient person, you love to share and also listen to what people say”. The prompt data may be retrieved and fed into the language model to give the chatbot a specific personality.

For example, the personality of “talkative” may be realized by feeding the input of “you are talkative”, “the answer has to be more than six sentences or over 100 words”. The app provider may also provide some default personality data for the user to select. In some embodiments, the prompt data may also be entered and set by the user or the like. For example, the user may select no personality or a default personality. The user may also enter a paragraph as the prompt data to give the AI chatbot a personality or the like.

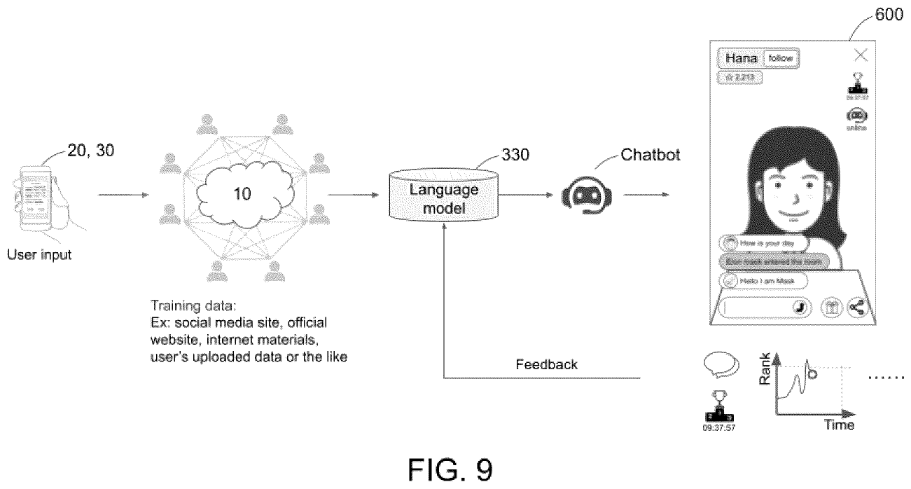

FIG. 9 is exemplary functional configuration of the live streaming system 1 according to some embodiments of subject application. As shown in FIG. 9, an AI chatbot may be generated and set in response to a user input from a user terminal of a user. In some embodiments, the generation of AI chatbot may also be performed by server 10 automatically. The user may set the information of the chatbot such as character or the like. In some embodiments, the user may further set the personality, additional features or the like. In response to the setting from the user, server 10 may collect the training data internally or externally from the internet or the like. For example, if the user set the character to be a follower of his or her, server 10 may collect the follower's public information stored in server 10 or externally from his or her social media sites or the like.

In some embodiments, if the user set a specific personality to the AI chatbot, the server 10 may refer to the personality DB 328 or the like to generate a chatbot of the follower with specific personality. Once the training data and personality data is collected, server 10 may further feed the training data and personality data into the language model 330 to generate a chatbot accordingly. The chatbot may be located and displayed in a livestreamer's live streaming room or the like.

In some embodiments, the processing unit 306 may monitor the situation of the live streaming room. For example, the processing unit 306 may monitor the comments, event information, receiving points or ranking of the livestreamer in an event or the like. The processing unit 306 may further feed the related information to the language model 330. The language model 330 may further generate response according to the related information to help the livestreamer handle the event or atmosphere in the live streaming room or the like. For example, if a user tags the chatbot and asks the chatbot to tell a joke, the processing unit 306 may feed the comment to the language model 330 and generate a joke for the user.

FIG. 10-FIG. 15 are exemplary screen images of a live-streaming room screen 600 shown on the display of the livestreamer user terminal 20 or the viewer user terminal 30. Once the viewer selects and enters a live-streaming room, a live streaming room screen 600 of the livestreamer may be shown on the display. The live streaming room screen 600 may include a livestreamer info object 602, livestreamer image 604, message zone 606, message input box 608, gift object 610, sharing object 612 or the like.

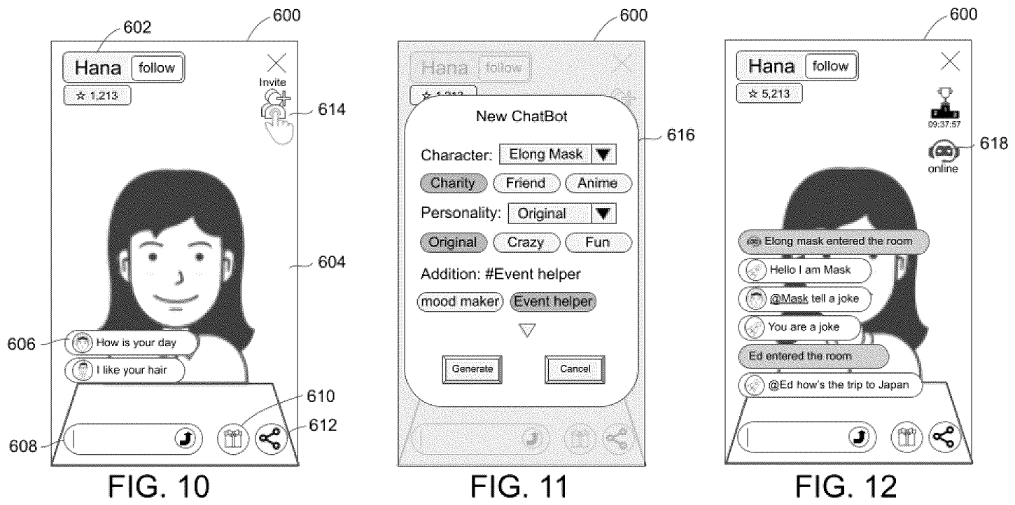

In some embodiments, the screen 600 may further include an invite button 614. The invite button 614 is configured to generate an AI chatbot in the live streaming room, which is just like inviting a user to join the live streaming room. As shown in FIG. 10, once the invite button 614 is clicked, an UI 616 may be displayed for the user to set an AI chatbot as in FIG. 11. In some embodiments, the UI 616 may include a form with options for the user to determine the character, personality, addition feature or the like.

In some embodiments, the UI 616 may include a column (not shown) for the user to enter a paragraph as prompt in order to generate a customized AI chatbot. For example, the user may enter “I would like to have an AI chatbot of super Mario with the personality of crazy to be a moodmaker in my live streaming room”, and the processing unit 306 may extract the keyword and generate an AI chatbot accordingly. In some embodiments, the design and setting of an AI chatbot may be determined flexibly.

Once the user finishes selection of the AI chatbot, the processing unit 306 may feed information of the AI chatbot to a machine learning model. Here, the language model 330 is used as an example for explanation. In some embodiments, the language model may be any possible or available model such as ChatGPT or the like. In some embodiments, the machine language models may infer the possible output according to the input and the procedure of generating the AI chatbot may refer to providing users with the inference from the models.

In some embodiments, the processing unit 306 may retrieve training data of the AI chatbot from a database in server 10 or from the internet. After generation of the AI chatbot, the processing unit 306 may display the AI chatbot in the live streaming room as shown in FIG. 12. In some embodiments, there may be an icon 618 to indicate that there is an AI chatbot in the live streaming room. In some embodiments, a mark (not shown) may also be displayed on the display image of the AI Chatbot or the like to indicate the identification of the AI chatbot.

As shown in FIG. 12, the AI chatbot may interact with the livestreamer and viewers. For example, the viewers may tag the AI chatbot and ask the AI chatbot to tell a joke or the like. The processing unit 306 may further monitor the status of the live streaming room and further feed the comment to the language model 330 to generate a response according to the comment from the viewers.

The AI chatbot may also tag the viewer to motivate the viewer to interact with the livestreamer. For example, the processing unit 306 may refer to a viewer's post in the live streaming platform or social media site. If the viewer just traveled back from Japan, the processing unit 306 may tag the viewer and ask the viewer about the trip in Japan via the AI chatbot. In some embodiments, the AI chatbot may cue or tag the viewers who are new to the live streaming room or the like. According to the embodiments, the new user may feel welcomed and involved in the live streaming room and the user experience may be improved.

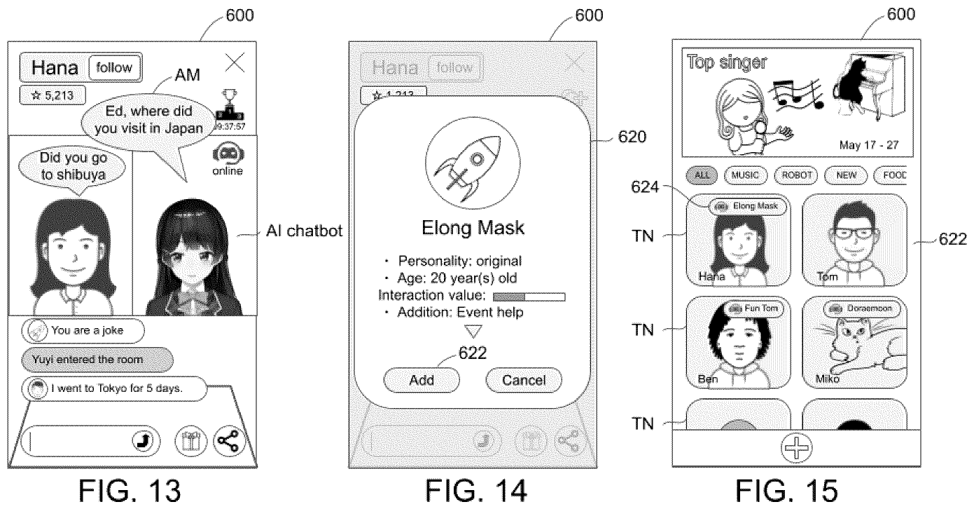

In some embodiments, the AI chatbot may perform similar or the same operation as the other users in the live streaming room as shown in FIG. 13. For example, the AI chatbot may have a group call, have a PK battle, have a game battle or the like with the livestreamer or the like. In some embodiments, the AI chatbot may also have an audio message AM to interact with the users. According to the embodiments, the AI chatbot may help the livestreamers control the atmosphere in the live streaming room and the user experience may be improved.

As shown in FIG. 14, the AI chatbot may have a profile page 620. The profile page 620 may be accessed by, for example, clicking on the display image of the AI chatbot or the like. In some embodiments, the profile page 620 of the AI chatbot may include detailed information of the AI chatbot such as the character, personality, level, age, interaction value, additional features or the like. In some embodiments, an add button 622 may also be provided on the profile page 620 for the user to add or follow the AI chatbot. In some embodiments, the other users may also tag, gift, send PK invitations, block, send direct messages to the AI chatbot or the like.

In some embodiments, the AI chatbot may be displayed on a thumbnail of the live streaming. As shown in FIG. 15, the user may request server 10 to provide the information of live streaming, and the streaming info unit 302 may refer to the stream DB 320 and generate a list of the available live streaming. Upon receiving the list, the UI control unit 202 of the user terminal 30 may generate a live streaming selection screen 622 according to the list and display the list on the display of the user terminal 30. In some embodiments, the live streaming selection screen 622 may include a thumbnail TN of each live streaming for the user to select.

In some embodiments, the thumbnail TN of the live streaming may include a mark 624 to indicate whether there is an AI chatbot in the live streaming or not. The user may receive more details on the AI chatbot by clicking on the mark 624 or the like. According to the embodiments, each livestreamer may generate their own AI chatbot and use it as a selling point to motivate more viewers to participate in their live streaming.

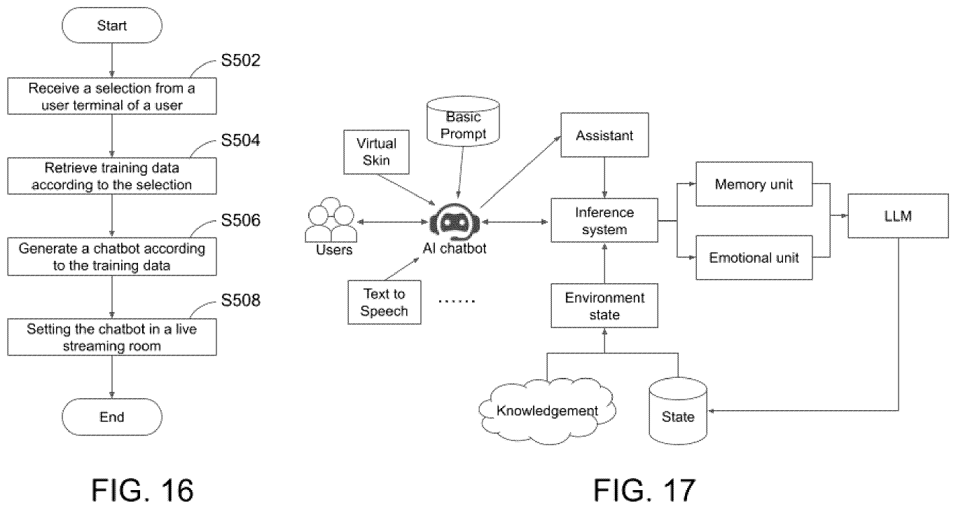

FIG. 16 is a flowchart showing steps of an application activation process on the user terminals 20 and 30. The users may generate an AI chatbot in the live streaming room. Upon receiving the selection of the AI chatbot from the user terminal of the user (S502), server 10 may retrieve the training data of the selected AI chatbot according to the selection of the user (S504). In some embodiments, the training data may be character data corresponding to a character. The character may be a celebrity, a user, an animation character or the like. The processing unit 306 may refer to the corresponding database in server 10 or refer to the resource on the internet such as social media sites, official websites or the like.

In some embodiments, the processing unit 306 may further feed the training data into a machine learning model such as a language model to generate an AI chatbot according to the training data (S506). In some embodiments, if the user sets a personality on the AI chatbot, the processing unit 306 may further refer to the personality DB 328 and add the corresponding prompt data to set the personality of the AI chatbot. After the generation of the AI chatbot, the processing unit 306 may set the AI chatbot in the live streaming room (S508) to let the AI chatbot interact with the users in the live streaming room. In some embodiments, the virtual chatbot may also provide assistance to a livestreamer or viewers in the live streaming room.

According to the present disclosure, the AI chatbot with a character may increase the interaction and fun in the live streaming room. Moreover, the monitoring and handling of the atmosphere in the live streaming may also be partially or entirely entrusted to the AI chatbot. Therefore, the user experience may be improved.

In some embodiments, the selection of character, personality, addition feature or the like may also be realized by a random button. For example, the user may click a random button to randomly generate an AI chatbot with a random character, personality, addition feature or the like. According to the embodiments, an AI chatbot with random character, personality, or feature may be generated, and the atmosphere in the live streaming room may be improved.

In some embodiments, the user may cue or tag the AI chatbot by text, audio, video message or the like. For example, the livestreamer may cue the AI chatbot by clicking a button, entering a specific message, saying a specific message, making a specific gesture or the like. According to the embodiments, the livestreamer may cue the AI chatbot easily for help when the atmosphere in the livestreaming room is low and the atmosphere in the live streaming room may be improved.

In some embodiments, there may be more than one AI chatbot in a live streaming room. One AI chatbot may also interact with another AI chatbot in the live streaming room. In some embodiments, the user may cue one AI chatbot to interact with another AI chatbot. The user may cue different AI chatbots to interact with each other. For example, the user may cue the AI chatbot of characters in Street Fighter and Nintendo to communicate, PK or the like. According to the embodiments, the fun in the live streaming room may be improved.

In some embodiments, the AI chatbot may be a guide in the live streaming room. The AI chatbot may guide the livestreamer or viewers to do the live streaming, watch the live streaming, interact with the livestreamer, playing a game or the like. In some embodiments, when a new feature such as a game is launched, the AI chatbot may experience the new feature in one live streaming room and share the experience in another live streaming room. According to the embodiments, the barrier for the user to experience new features may be reduced and the user experience may be improved.

In some embodiments, the AI chatbot may mute, kick out, block a user in the live streaming room if the user violates rules in the live streaming platform. For example, if a user's comments include dirty words or illegal points information, the AI chatbot may mute or kick the user out of the live streaming room. In some embodiments, the AI chatbot may perform the above operation automatically or based on the request from the livestreamer or the other users. According to the embodiments, the AI chatbot may help the livestreamer with the handling of the atmosphere in the live streaming room.

In some embodiments, the AI chatbot may be generated by spending points in the live streaming platform or the like. In some embodiments, AI chatbot may only be generated by the user with specific level or status such as above level 80 or VIP status. In some embodiments, the points for generating an AI chatbot may be paid by one user or split by more than one user. In some embodiments, the points for generating more than one AI chatbot may be the same or increased according to the number of AI chatbot or the like.

In some embodiments, the character, personality, or features of the chatbot may also be trained by the input from the user in the live streaming room. The user may feed input as prompt data to give the AI chatbot a brand-new personality or the like. In some embodiments, each user may have their own AI chatbot with customized character, personality, or features. In some embodiments, a campaign may also be held for the user to show their own AI chatbot and have them compete with each other.

The AI chatbot may respond to the interaction from the users in the live streaming room. In some embodiments, the AI chatbot may automatically provide a topic or generate conversation periodically or when the atmosphere in the live streaming room is low or the like. For example, the AI chatbot may provide the latest news in each hour or provide horoscope information when there is no interaction in the live streaming room.

In some embodiments, the AI chatbot may also receive the information of the users internally in the live streaming platform or externally from their social media site, and further cue the users according to their information. For example, a user posts an article about a trip to Thailand in the live streaming platform, and the AI chatbot may retrieve information from the article. Once the user enters a live streaming room, the AI chatbot may cue the user and ask about the trip in Thailand. According to the embodiments, it may help establish topics between the livestreamer and the user, and also motivate the user to interact more with the users in the live streaming room.

In some embodiments, the AI chatbot may also collect information of the history interaction between a user and the livestreamer, and then provide the information to the livestreamer. For example, if the livestreamer talked with the user three days ago or clicked good on the user's article yesterday, the AI chatbot may provide a hint message to the livestreamer to remind the livestreamer of the interaction with the user. According to the embodiments, it may help the livestreamer remember the user and the user experience may also be improved.

In some embodiments, the AI chatbot may memorize the information of the users from the interaction with the users. For example, if the user tells the AI chatbot that he is a taurus, the AI chatbot may receive the information and store the information in the training data DB, user DB or the like. More specifically, the processing unit 306 may further retrieve the interaction in the live streaming room and update the training data DB or user DB in real-time. According to the embodiments, the interaction between the AI chatbot and the user may be smooth and the user experience may be improved.

In some embodiments, the AI chatbot may also start a live streaming or the like. In some embodiments, the AI chatbot may provide information related to its character. For example, if the AI chatbot is a fortune teller or astrologer, the AI chatbot may provide horoscope information in its live streaming or the like. In some embodiments, the design and function of the AI chatbot may be determined flexibly according to the practical need.

In some embodiments, the AI chatbot may receive the interaction between the livestreamer and viewers, and to learn the way how the livestreamer interacts with the viewers. In some embodiments, the AI chatbot may also be trained to talk, interact with viewers, play games like the livestreamer or the like. In some embodiments, the livestreamer may set the AI chatbot as a substitute livestreamer while the livestreamer is unavailable. For example, the livestreamer or viewers may set the AI chatbot as a substitute player to excuse themselves from an on-line Mahjong game to go to the bathroom or the like. In some embodiments, a switch button may also be provided for the user to set the auto-playing or auto-interaction mode to let the AI chatbot play the game or interact with the viewers for them or the like.

In some embodiments, the Natural Language Processing technology such as TTS (Text-to-Speech) and STT (Speech-to-Text) may also be introduced. For example, the audio data such as voice from the livestreamer may also be converted into text information and fed into the machine learning model, and the text output may also be converted into speech so that the AI chatbot may respond to the user via audio data or the like. In some embodiments, the tone, pitch, timbre, tempo, speed of an audio message may change according to their emotion. For example, the AI chatbot may speak in a high pitch and fast speed while being very exciting or the like.

In some embodiments, an avatar or a virtual skin for the AI chatbot may also be set. In some embodiments, the avatar or virtual skin may be provided by the platform provider or customized by the users themself or the like. In some embodiments, the facial features, gesture, motion of the AI chatbot may change according to their emotion. For example, the AI chatbot may smile while receiving gifts, and an angry face may be shown while receiving negative messages. In some embodiments, the avatar and virtual skin may be provided by server 10 or by a third-party software such as Live2D, VRoid Hub or the like.

In some embodiments, the emotion of the AI chatbot may change according to the livestreamer's status in the live streaming room. For example, the AI chatbot may show a positive emotion such as happiness if the livestreamer receives gifts over a specific point or wins the reward in an event or the like. In some embodiments, a look-up table may also be provided to store the relationship between specific achievements and the corresponding emotion. For example, the AI chatbot may be happy if the receiving point is over 1,000 points and the AI chatbot may dance if the receiving point is over 10,000 points or the like.

In some embodiments, server 10 may further include an emotion unit to handle the emotion of the AI chatbot. The emotion unit may be configured to handle the emotion of the AI chatbot such as the information of the text, audio and video message from the AI chatbot. In some embodiments, the emotion of the AI chatbot may change randomly or periodically. For example, the AI chatbot may change its emotion everyday or the like. The information of emotion may be received from the internet or the like.

In some embodiments, the emotion unit may refer to an internal database or external resource such as an astrology website to receive individual horoscopes, and further determine the emotion according to the horoscope. For example, if the AI chatbot is set to be an astrologer with the zodiac sign Taurus, the emotion unit may refer to the astrology website to retrieve the individual horoscope of Taurus on that day. If the individual horoscope of Taurus indicates that it is a lucky day, the emotion unit may set a positive emotion on the AI chatbot or the like.

In some embodiments, server 10 may further include a memory unit to handle the interaction of the AI chatbot with the user in the live streaming room. The memory unit may be configured to memorize the information of the user in the live streaming room. For example, if a user says that he is Gemini, the memory unit may extract the information from the message and store the information in, for example, the user DB 322 or training data DB 326 or the like. Once the user interacts with the AI chatbot, the information may further be used as a topic or the like. For example, if the user enters the live streaming room the other day, the AI chatbot may say “nice to meet you again” and provide the Gemini's horoscope for this week for reference.

FIG. 17 is exemplary functional configuration of the live streaming system 1 according to some embodiments of subject application. In some embodiments, the live streaming system 1 may further include an inference system. The inference system may be configured to infer a mood or emotion to be set on the AI chatbot. As shown in FIG. 17, the AI chatbot may be implemented with different features. In some embodiments, the customized virtual skin, text to speech, speech to text, character data, prompt data, or the like may be implemented to the AI chatbot. In some embodiments, the above technology may be used separately or in combination.

In some embodiments, the interaction between the AI chatbot and the users may also be fed into the AI chatbot. The data in the AI chatbot may further be transmitted to the inference system. In some embodiments, the AI chatbot may also work as an assistant and the corresponding data may also be transmitted to the inference system. Moreover, the environment status of the live streaming room may also be fed into the inference engine in real-time.

In some embodiments, the environment status may include the knowledgement and status of the live streaming room. Here, the “knowledgement” may refer to the topic in the live streaming room. In some embodiments, the AI chatbot may collect the topics the users are interested in according to the character data and personality data of the AI chatbot. The “status” may refer to the current status in the live streaming room. For example, the status of the live streaming room may be the receiving points of the livestreamer, the time length of broadcasting, the number of followers or subscribers or the like.

In some embodiments, all the information above may be transmitted to the inference system. Based on the above input, the inference system may infer a possible mood index by the emotion unit. Here, the mood index may refer to the mood of the AI chatbot. For example, if the character of the AI chatbot is an Aquarius, the inference engine may use the Aquarius's horoscope today to generate a mood index. Moreover, the interaction in the live streaming room or the topic users are interested in may also be used as an input to generate a mood index. The index may further be fed into a machine learning model such as Large Language Model (LLM) or the like. Moreover, the interaction information stored by the memory unit may also be fed into the machine learning model.

In some embodiments, the procedure may be performed randomly or periodically such as once a day. In some embodiments, the mood of the AI chatbot may be determined based on the above procedure. According to the embodiments, the interaction between the AI chatbot and the users may vary according to the mood of the AI chatbot. Even if the interactions from the user are similar, the AI chatbot may generate different output based on different moods. Therefore, the fun in the live streaming room may increase and the user experience may be improved.

According to the embodiments, the original AI chatbot may be trained by the inference system, memory unit, emotion unit or the like. Therefore, a unique AI chatbot with extra prompt data may be obtained. In some embodiments, the output from the LLM may also be provided as the status in the live streaming room, and further fed into the inference engine again as a loop. Therefore, the AI chatbot may have different character, personality, emotion, mood day by day, and the interaction between the AI chatbot and the users may be unpredictable and much more interesting. Therefore, the user experience may also be improved.

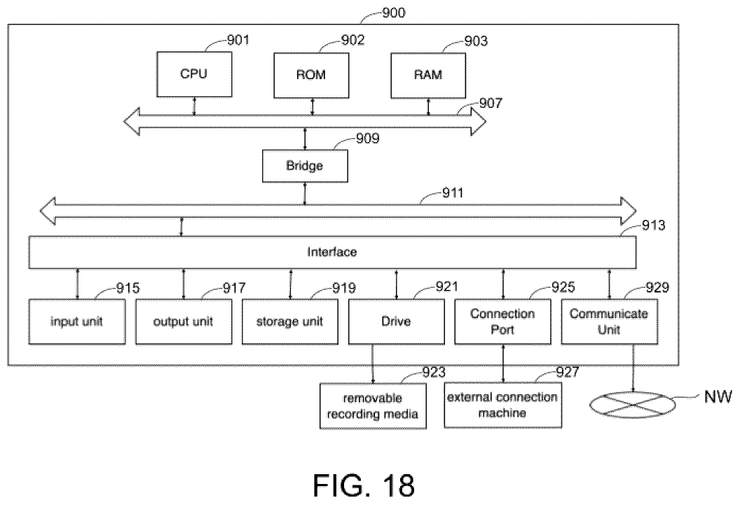

FIG. 18 is a schematic block diagram of computer hardware for carrying out a system configuration and processing according to some embodiments of subject application. The information processing device 900 in FIG. 18 is, for example, is configured to realize the server 10 and the user terminal 20, 30 respectively according to some embodiments of subject application.

The information processing device 900 includes a CPU 901, read only memory (ROM) 903, and random-access memory (RAM) 905. In addition, the information processing device 900 may include a host bus 907, a bridge 909, an external bus 911, an interface 913, an input unit 915, an output unit 917, a storage unit 919, a drive 921, a connection port 925, and a communication unit 929. The information processing device 900 may include imaging devices (not shown) such as cameras or the like. The CPU 901 is an example of hardware configuration to realize various functions performed by the components described herein. The functions described herein may be realized by circuitry programmed to realize such functions described herein. The circuitry programmed to realize such functions described herein includes a central processing unit (CPU), a digital signal processor (DSP), a general-use processor, a dedicated processor, an integrated circuit, application specific integrated circuits (ASICs) and/or combinations thereof. Various units described herein as being configured to realize specific functions, including but not limited to the streaming unit 100, the viewing unit 200, the video control unit 102, the audio control unit 104, the distribution unit 106, the UI control unit 108, the UI control unit 202, the rendering unit 204, the input transmit unit 206, the streaming info unit 302, the relay unit 304, the processing unit 306, the stream DB 320, the user DB 322, the AI chatbot DB 324, the training data DB 326, the personality DB 328, the machine learning model 330 and so on, may be embodied as circuitry programmed to realize such functions.

The CPU 901 functions as an arithmetic processing device and a control device, and controls the overall operation or a part of the operation of the information processing device 900 according to various programs recorded in the ROM 903, the RAM 905, the storage unit 919, or a removable recording medium 923. For example, the CPU 901 controls overall operations of respective function units included in the server 10 and the user terminal 20 and 30 of the above-described embodiment. The ROM 903 stores programs, operation parameters, and the like used by the CPU 901. The RAM 905 transiently stores programs used when the CPU 901 is executed, and parameters that change as appropriate when executing such programs. The CPU 901, the ROM 903, and the RAM 905 are connected with each other via the host bus 907 configured from an internal bus such as a CPU bus or the like. The host bus 907 is connected to the external bus 911 such as a Peripheral Component Interconnect/Interface (PCI) bus via the bridge 909.

The input unit 915 is a device operated by a user such as a mouse, a keyboard, a touchscreen, a button, a switch, and a lever. The input unit 915 may be a device that converts physical quantity to electrical signal such as audio sensor (such as microphone or the like), acceleration sensor, tilt sensor, infrared radiation sensor, depth sensor, temperature sensor, humidity sensor or the like. The input unit 915 may be a remote-control device that uses, for example, infrared radiation and another type of radio waves. Alternatively, the input unit 915 may be an external connection device 927 such as a mobile phone that corresponds to an operation of the information processing device 900. The input unit 915 includes an input control circuit that generates input signals on the basis of information which is input by a user to output the generated input signals to the CPU 901. The user inputs various types of data and indicates a processing operation to the information processing device 900 by operating the input unit 915.

The output unit 917 includes a device that can visually or audibly report acquired information to a user. The output unit 917 may be, for example, a display device such as an LCD, a PDP, and an OLED, an audio output device such as a speaker and a headphone, and a printer. The output unit 917 outputs a result obtained through a process performed by the information processing device 900, in the form of text or video such as an image, or sounds such as audio sounds.

The storage unit 919 is a device for data storage that is an example of a storage unit of the information processing device 900. The storage unit 919 includes, for example, a magnetic storage device such as a hard disk drive (HDD), a semiconductor storage device, an optical storage device, or a magneto-optical storage device. The storage unit 919 stores therein the programs and various data executed by the CPU 901, and various data acquired from an outside.

The drive 921 is a reader/writer for the removable recording medium 923 such as a magnetic disk, an optical disc, a magneto-optical disk, and a semiconductor memory, and built in or externally attached to the information processing device 900. The drive 921 reads out information recorded on the mounted removable recording medium 923, and outputs the information to the RAM 905. The drive 921 writes the record into the mounted removable recording medium 923.

The connection port 925 is a port used to directly connect devices to the information processing device 900. The connection port 925 may be a Universal Serial Bus (USB) port, an IEEE1394 port, or a Small Computer System Interface (SCSI) port, for example. The connection port 925 may also be an RS-232C port, an optical audio terminal, a High-Definition Multimedia Interface (HDMI (registered trademark)) port, and so on. The connection of the external connection device 927 to the connection port 925 makes it possible to exchange various kinds of data between the information processing device 900 and the external connection device 927.

The communication unit 929 is a communication interface including, for example, a communication device for connection to a communication network NW. The communication unit 929 may be, for example, a wired or wireless local area network (LAN), Bluetooth (registered trademark), or a communication card for a wireless USB (WUSB).

The communication unit 929 may also be, for example, a router for optical communication, a router for asymmetric digital subscriber line (ADSL), or a modem for various types of communication. For example, the communication unit 929 transmits and receives signals on the Internet or transmits signals to and receives signals from another communication device by using a predetermined protocol such as TCP/IP. The communication network NW to which the communication unit 929 connects is a network established through wired or wireless connection. The communication network NW is, for example, the Internet, a home LAN, infrared communication, radio wave communication, or satellite communication.

The imaging device (not shown) is a device that images real space using an imaging device such as a charge coupled device (CCD) or a complementary metal oxide semiconductor (CMOS), for example, and various members such as a lens for controlling image formation of a subject image on the imaging device and generates a captured image. The imaging device may capture a still picture or may capture a movie.

The present disclosure of the live streaming system 1 has been described with reference to embodiments. The above-described embodiments have been described merely for illustrative purposes. Rather, it can be readily conceived by those skilled in the art that various modifications may be made in making various combinations of the above-described components or processes of the embodiments, which are also encompassed in the technical scope of the present disclosure.

The procedures described herein, particularly flowchart or those described with a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present disclosure.

In some embodiments, at least a part of the functions performed by the server 10 may be performed by other than the server 10, for example, being performed by the user terminal 20 or 30. In some embodiments, at least a part of the functions performed by the user terminal 20 or 30 may be performed by other than the user terminal 20 or 30, for example, being performed by the server 10. In some embodiments, the rendering of the frame image may be performed by the user terminal of the viewer, the server, the user terminal of the livestreamer or the like.

Furthermore, the system and method described in the above embodiments may be provided with a computer-readable non-transitory storage device such as a solid-state memory device, an optical disk storage device, or a magnetic disk storage device, or a computer program product or the like. Alternatively, the programs may be downloaded from a server via the Internet.

In the examples of the present application, the method can be applied to the server, viewer side, or streamer side, but not limited thereto. The implementation devices may include electronic devices such as smartphones, desktop computers, notebook computers, or tablet computers, but are not limited thereto.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed but includes another variation and modification that do not disobey the present disclosure, and is the scope covered by the following patent application scope.

What is claimed is:

1. A server comprising a circuitry, wherein the circuitry is configured to perform:
receiving a character data corresponding to a character;
feeding the character data into a machine learning model to generate a virtual chatbot in a live streaming room;
setting the virtual chatbot in the live streaming room; wherein
the virtual chatbot is configured to provide assistance to a livestreamer or viewers in the live streaming room.

2. The server according to claim 1, further comprising:
receiving a selection of the character from a first user, wherein
the character data of the character is retrieved internally from a database of the server or externally from a resource related to the character on the internet; and
the character is a celebrity, a user in the live streaming platform or an animation character.

3. The server according to claim 1, further comprising:
receiving a selection of a personality from a first user, wherein
retrieving a prompt data corresponding to the personality; and
feeding the prompt data into the machine learning model to generate the personality on the virtual chatbot.

4. The server according to claim 1, further comprising:
receiving status of the livestreaming room while a livestreamer being participating in an event; and
displaying a hint message via the virtual chatbot in response to a trigger being detected during the event; wherein
the hint message includes information on guiding the livestreamer or the other users in the event.

5. The server according to claim 1, further comprising:
retrieving information of a user in the live streaming room; and
tagging the user according to the information of the user via the virtual chatbot.

6. The server according to claim 1, further comprising:
receiving interaction from users in the live streaming room;
inputting the interaction into the machine learning model;
generating an output from the machine learning model; and
transmitting the output to the live streaming room via the virtual chatbot.

7. The server according to claim 1, wherein:
the virtual chatbot include a level and an interaction value;
the level and interaction value increases according to historical interaction of the virtual chatbot with users; and
real-time interaction from the virtual chatbot to the users varies according to the level and interaction value of the virtual chatbot.

8. The server according to claim 1, wherein:
information of the virtual chatbot is further displayed on a thumbnail of the live streaming room.

9. A method for handling interaction in a live streaming platform, comprising:
receiving a character data corresponding to a character;
feeding the character data into a machine learning model to generate a virtual chatbot in a live streaming room;
setting the virtual chatbot in the live streaming room; wherein
the virtual chatbot is configured to provide assistance to a livestreamer or viewers in the live streaming room.

10. A non-transitory computer-readable medium including program instructions, that when executed by one or more processors, cause the one or more processors to execute:
receiving a character data corresponding to a character;
feeding the character data into a machine learning model to generate a virtual chatbot in a live streaming room;
setting the virtual chatbot in the live streaming room: wherein
the virtual chatbot is configured to provide assistance to a livestreamer or viewers in the live streaming room.
